(19) United States
(12) Patent Application Publication
(10) Pub. No.: US 2008/0016702 A1
(43) Pub. Date: Jan. 24, 2008

(54) LAMINA CUTTER WITH DISPOSABLE GUARD

(76) Inventor: Anthony J. Domenico, Menifee, CA (US)

Correspondence Address: NEIL K. NYDEGGER;NYDEGGER & ASSOCIATES, 348 Olive Street, San Diego, CA, 92103, US

(21) Appl. No.: 11/830,258

(22) Filed: Jul. 30, 2007

Related U.S. Application Data
(63) Continuation-in-part of application No. 10/830,366, filed on Apr. 22, 2004.

(51) Int. Cl. B26B 3/00

(52) U.S. Cl. 30/294

(57) ABSTRACT

A lamina cutter includes a handle with opposite parallel surfaces, proximal and distal ends, and edges that extend between the surfaces and between the ends. Further, the handle forms a groove positioned between the surfaces adjacent the distal end. Also, the lamina cutter includes a plurality of disposable guarded blades. Each guarded blade includes a planar blade member permanently bonded to a guard member. Specifically, each blade member has opposite side edges, with one side edge mounted within, and bonded to the guard member. Further, the opposite side edge of the blade is received within, and detachably connected to, the groove of the handle.

This application is a continuation-in-part of application Ser. No. 10/830,366 filed Apr. 22, 2004, which is currently pending. The contents of application Ser. No. 10/830,366 are incorporated herein by reference.

### FIELD OF THE INVENTION

The present invention pertains generally to disposable cutting instruments. More particularly, the present invention pertains to disposable cutting instruments that incorporate safety features which prevent accidental injury to the user. The present invention is particularly, but not exclusively, useful as a safety cutter with a disposable guarded blade for cutting laminae.

### BACKGROUND OF THE INVENTION

Regardless of the nature of an item that is to be cut, or the nature of the device or mechanism that is to be used to cut the item, safety is always an issue.

Anytime the cutting edge of a blade is exposed, and left unprotected, a safety issue is presented that needs to be consciously addressed. Typically, proper training in the use of knives, scissors, saws and other type cutting instruments is relied on for the prevention of accidents. Despite abundant precautions, however, and even with proper training, accidents do happen. Thus, in order to further reduce the probability that an exposed cutting edge will cause an injury accident, it is preferable for the instrument to include a safety feature that is intended to prevent such incidents.

An activity that is very commonly accomplished by using the exposed cutting edge of a blade is the cutting of a lamina. More specifically, and as intended here, a lamina can be any structure that is formed as a thin layer, plate or sheet; and that is made of a material that can be cut by a hand-operated implement. For example, laminae include, but are certainly not limited to, such items as paper, cardboard, cloth, clothing, straps, leather, canvas and plastic sheets. In each example, the laminar structure that is to be cut is thin. Further, unless it is being cut, the laminar structure is otherwise strong and generally tear-resistant.

In order to cut a lamina using a hand-held instrument, the lamina must somehow be exposed to the cutting element of the instrument. On the other hand, it is desirable that the user of the instrument be somehow protected from the cutting element while it is being used. Of course, although the user is protected, the cutting element must still be able to make contact with the object that is to be cut.

In addition to safety concerns, handheld instruments for cutting lamina often wear out or are damaged, leading to short working lives. For such instruments, the handle portion typically retains substantial working life at the time of disposal. Therefore, it would be an improvement to provide a detachable and disposable guarded blade for use with a safety cutter handle.

In light of the above, it is an object of the present invention to provide a safety cutter for cutting laminae that establishes dimensions for an access to the cutting element that effectively prevents the accidental insertion of an appendage (e.g. a finger) through the access and into contact with the cutting edge. Another object of the present invention is to provide a safety cutter for cutting laminae that allows a lamina to be cut without dangerously exposing the user to the cutting element. Yet another object of the present invention is to provide a handheld safety cutter that allows use of a plurality of replacement guarded blades. Still another object of the present invention is to provide a safety cutter with a disposable guarded blade for cutting laminae that is easy to use, is relatively simple to manufacture, and is comparatively cost effective.

### SUMMARY OF THE INVENTION

A safety cutter for cutting a lamina includes a substantially flat, elongated stainless steel cutting blade. The cutting blade defines an axis that lies between a first side edge and a second side edge that are both substantially coplanar with the axis. Additionally, the cutting blade has an in-plane cutting edge that extends between the first side edge and the second side edge.

With the blade configuration described above, a guard member is affixed to the first side edge of the blade, and a handle is affixed to the second side edge of the blade. In this combination, the handle and the guard member are opposite the blade axis from each other, and they establish a channel between them which has a width “w” of a predetermined distance. The blade is thus held in the channel between the handle and the guard member for cutting a lamina as the lamina is advanced along the axis and through the channel.

It is an important safety feature of the present invention that the width “w” of the channel is designed to be less than the width of a finger. Typically, the width “w” will be greater than approximately 0.125 inches. Further, the cutting edge of the blade is recessed in the channel so that a finger of the user can not enter the channel and come in contact with the cutting edge.

Several different embodiments of the present invention can be envisioned. For instance, the shape of the handle can be varied as desired. For another, the cutting edge of the blade may be inclined at a variable angle α relative to the axis. Specifically, for one embodiment of the safety cutter, the angle α can be less than ninety degrees (α<90°). In another embodiment, the angle α can be greater than ninety degrees (α>90°).

As intended for the operation of the safety cutter of the present invention, the lamina to be cut can be taken from a wide variety of materials. For example, the lamina can be paper, cardboard, cloth or plastic sheets. In any event, it is important that the lamina have a thickness “t” that is less than the width “w” of the channel in the safety cutter.

In certain embodiments of the present invention, the safety cutter is intended to use disposable guarded blades. Specifically, such a cutter includes a handle that has opposite substantially parallel surfaces, proximal and distal ends, and edges that extend between the surfaces and between the ends. Further, the handle forms a groove positioned between the surfaces which extends from one edge toward the other. Also, the safety cutter is equipped with a plurality of guarded blades. For purposes of the present invention, each guarded blade includes a planar blade member permanently bonded to a guard member. Structurally, each blade member has a top surface and a bottom surface with a substantially uniform distance “u” therebetween. Also, each blade member has opposite side edges interconnected by a cutting edge and a distal edge. For each guarded blade, the guard member is permanently bonded to a side edge of the blade member.

To cut a lamina with the safety cutter, a guarded blade is selected for use. Then, the free side edge of the blade member of the selected guarded blade is connected to the groove in the handle. As a result, the blade member is held in a channel between the handle and the guard member. Further, the channel extends between the cutting edge and the distal edge of the blade member so that the surfaces of the blade member are exposed in the channel from the cutting edge to the distal edge.

Thereafter, the proximal end of the handle is gripped and the lamina is positioned adjacent the cutting edge of the blade member. The proximal end of the handle is then pulled away from the distal end of the handle to advance the lamina through the channel and against the cutting edge to cut the lamina.

When the blade member is worn out or replacement is otherwise desired, the blade member is disconnected from the groove of the handle. Then, another guarded blade is selected and the process is repeated. As a result, the handle portion of the safety cutter need not be disposed of when the blade must be replaced.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a safety cutter of the present invention being used to cut a lamina;

FIG. 2 is an elevation view of an embodiment of a safety cutter in accordance with the present invention, with portions of the blade shown in phantom for clarity;

FIG. 3 is an elevation view of another embodiment of a safety cutter in accordance with the present invention;

FIG. 4 is a top view of the safety cutter shown in FIG. 2, as seen along the line 4-4 in FIG. 2;

FIG. 5 is a perspective view of another embodiment of a safety cutter in accordance with the present invention;

FIG. 6 is an elevation view of the safety cutter of FIG. 5, with certain internal features shown in phantom; and

FIG. 7 is an elevation view of the removable guarded blade from the safety cutter of FIG. 5.

### DESCRIPTION OF THE PREFERRED EMBODIMENTS

Referring initially to FIG. 1 a safety cutter in accordance with the present invention is shown, in use, and is generally designated 10. In combination, the cutter 10 includes a handle 12 and a guard member 14 that cooperate with each other to hold a cutting blade 16 between them. With this combination, as shown, the cutter 10 is useful for cutting a lamina 18. As intended for the present invention, the lamina 18 can be any thin structure that has a thickness “t”. Further, the lamina 18 can be made from a variety of materials, to include: paper, cardboard, cloth, clothing, straps, leather, canvas and plastic sheets.

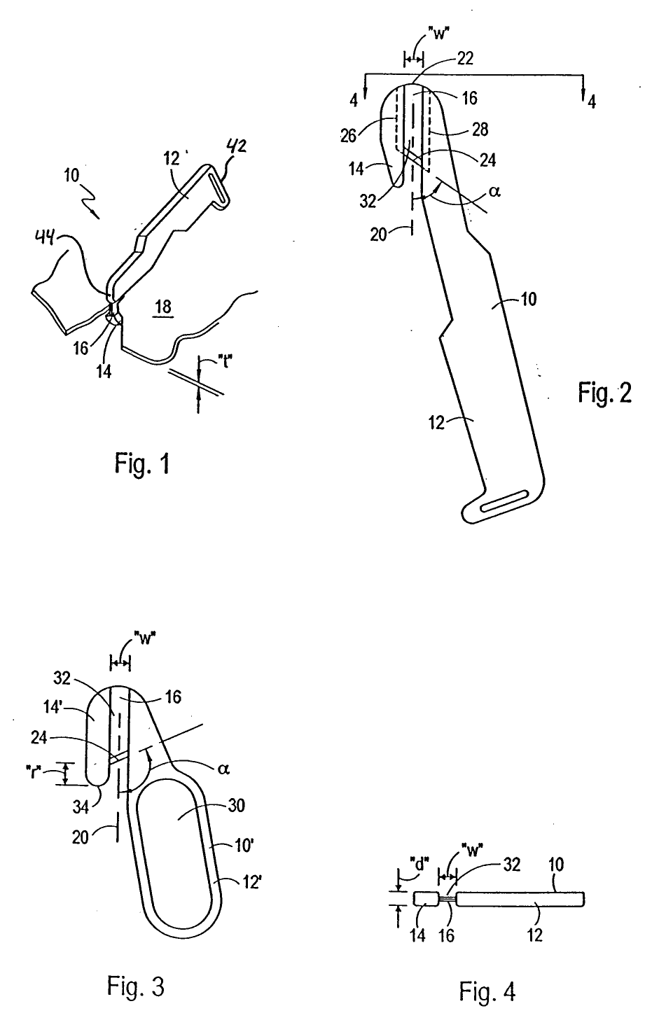

The structural details of blade 16, as it is mounted on the cutter 10, will be best appreciated by referring to FIG. 2. For the present invention, the blade 16 is preferably flat and is made of a stainless steel, or of some other strong material that is capable of cutting a particular lamina 18 (e.g. a reinforced plastic). As shown in FIG. 2, the blade 16 is elongated and defines an axis 20 that extends lengthwise along the blade 16 from an end 22 to a straight cutting edge 24. Further, the blade. 16 is bounded by a side edge 26 (shown in phantom) and a side edge 28 (also shown in phantom). Both of the side edges 26 and 28 of blade 16 are substantially parallel to the axis 20 and are on opposite sides of the axis 20.

In the construction of the cutter 10 of the present invention, both the handle 12 and guard member 14 are preferably made of a moldable plastic material. In particular, by cross-referencing the cutter 10. (shown in FIG. 2) with the cutter 10′ (shown in FIG. 3), it will be appreciated that the actual shape of the handle 12 can be molded to present additional features as desired. For example, the handle 12′ of cutter 10′ is shown formed with a finger grip 30. In any event, the handle 12 and the handle 12′ serve substantially the same functionality, and each is affixed to the side edge 28 of blade 16 in any manner well known in the pertinent art, such as by bonding, gluing or mechanical fixation. Similarly, the guard member 14 is affixed to the side edge 26 of blade 16. The consequence here is that a channel 32 is established between the handle 12 and the guard member 14, with the blade 16 and its cutting edge 24 positioned in the channel 32.

Again, by cross-referencing the cutter 10 (shown in FIG. 2) with the cutter 10′ (shown in FIG. 3), it will be appreciated that in all important respects, the cutter 10 is similar to the cutter 10′. Some design features, however, may differ. For instance, as mentioned above, the handle 12 of cutter 10 may be different in shape from the handle 12′ of the cutter 10′. Another difference may be the inclination and the degree of the angle α of the cutting edge 24. As shown, the inclination angle α of cutting edge 24 in cutter 10 is different from the inclination angle α for the cutting edge 24 in cutter 10′. Specifically, for the cutter 10 the angle α is less than ninety degrees (FIG. 2), while the angle α for the cutter 10′ is greater than ninety degrees (FIG. 3). Further, although the cutting edge 24 is shown to be straight, it will be appreciated that the cutting edge 24 may be curved, serrated of otherwise configured, as desired.

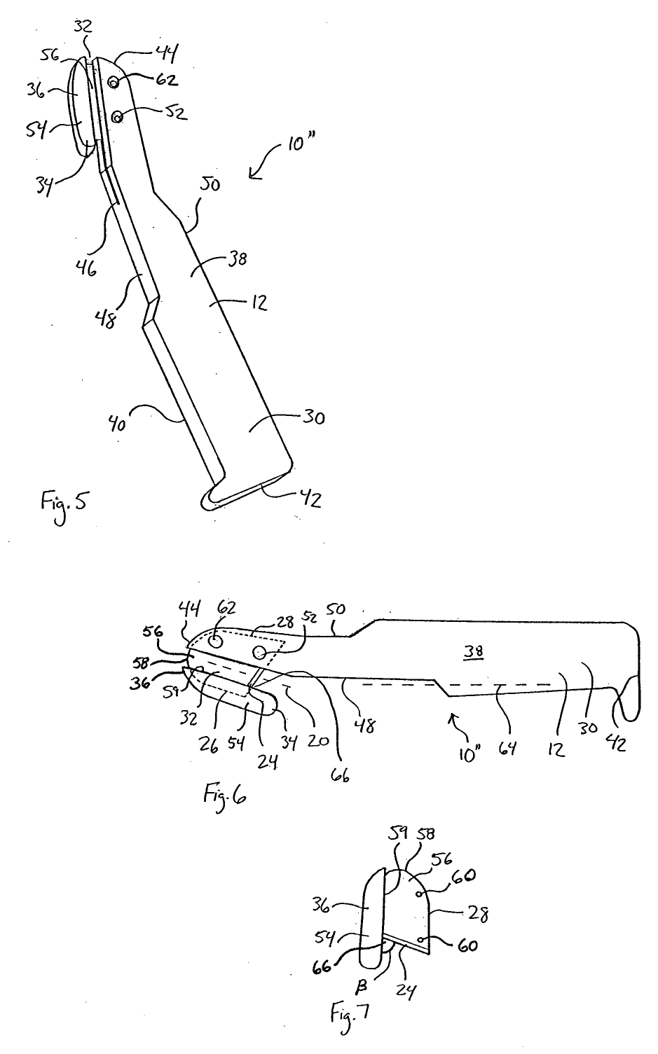

An important aspect of the present invention is that the width “w” of the channel 32 be greater than the thickness “t” of the lamina 18. Also, it is important that the cutting edge 24 of blade 16 be recessed into the channel 32 by at least the distance “r” from the nose 34 of guard member 14 (see FIG. 3). For safety reasons, the width “w” and recess distance “r” need to be sufficient to prevent the user of cutter 10 from accidentally inserting an appendage (e.g. a finger) into the channel 32 and into contact with the cutting edge 24. As an additional consideration, the sideways distance “d” (see FIG. 4) must be sufficient for this same purpose.

In another embodiment of the present invention, shown in FIGS. 5-7, the safety cutter 10″ is provided with a replaceable guarded blade 36. As shown in FIGS. 5 and 6, the safety cutter 10″ includes a handle 12 designed to be held in one of the user's hands. Structurally, the handle 12 has a surface 38 and a parallel opposite surface 40 that extend from a proximal end 42 to a distal end 44. At the distal end 44, the handle 12 forms a groove 46 that is positioned between and parallel to the surfaces 38, 40. Further, the groove 46 is approximately equidistant to each surface 38, 40. As can be seen in FIG. 5, the handle 12 includes an edge 48 and an opposite edge 50. For purposes of the present invention, the groove 46 extends from the edge 48 toward the edge 50, but does not intersect the edge 50. Also, the handle 12 forms two apertures 52 at the distal end 44 which extend from the surface 38 to the surface 40 and pass through the groove 46.

In FIGS. 5 and 6, the safety cutter 10″ is shown to further include a replaceable guarded blade 36. As shown in FIG. 7, the guarded blade 36 includes a guard member 54 permanently bonded to a blade member 56. As shown in FIG. 6, the blade member 56 includes a cutting edge 24, a side edge 26, an opposite side edge 28, and a curved distal edge 58. In FIG. 7, it can be seen that the blade member 56 is provided with two bores 60 adjacent its edge 28 which correspond with the apertures 52 in the handle 12.

For purposes of the present invention, the blade member 56 is permanently bonded to the guard member 54 from the edge 26 (shown in FIG. 6) of the blade member 56 to the edge 59 of the guard member 54. Structurally, the entire edge 26 is received within the guard member 54, which is preferably a hard plastic material. The adhesion between the hard plastic guard member 54 and the blade member 56 prevents mechanical separation of the two members 54, 56 without use of chemicals or extreme heat. For the purposes of the present invention, “permanently bonded” describes the adhesive relationship between the members 54, 56 which requires chemical or heat treatment for separation. In other words, the members 54, 56 cannot be separated without their own destruction.

Unlike the bond between the blade member 56 and the guard member 54, the blade member 56 is detachably connected to the distal end 44 of the handle 12. As shown in FIG. 5, the blade member 56 is partially received within the groove 46 in the handle 12. Further, when the blade member 56 is positioned within the groove 46, the apertures 52 and the bores 60 are aligned. In order to detachably fix the blade member 56 to the handle 12, fasteners 62 are passed through the aligned apertures 52 and bores 60. For ease of use, the fasteners 62 may be threaded and include an engagement surface for interaction with a screw driver. Of course, other detachable fasteners 62 are envisioned for the present invention.

In FIGS. 5 and 6, it can be seen that, when interconnected, the guarded blade 36 and the handle 12 form a channel 32 that extends along a cutting axis 20. As shown, the cutting axis 20 is substantially parallel to the edge 48 of the handle 12 at its distal end 44. Further, the cutting axis 20 is substantially parallel to the edge 59 of the guard member 54. As a result, the channel 32 has a substantially constant width between the edge 59 of the guard member 54 and the edge 48 of the handle 12. Further, only the blade member 56 extends across the width of the channel 32 (i.e., the guard member 54 and the handle 12 are completely separated by the channel 32).

Cross-referencing the cutter 10″ of FIGS. 5 and 6 with the cutter 10 (shown in FIG. 2) and the cutter 10′ (shown in FIG. 3), it will be appreciated that in some important respects, the cutter 10″ is similar to the cutters 10 and 10′. As shown in FIGS. 5 and 6, the inclination and the degree of the angle α of the cutting edge 24 is similar to the cutter 10. Specifically, for the cutters 10 and 10″ the angle α is less than ninety degrees (FIG. 2).

An important aspect of this embodiment of the present invention is that the width “w” of the channel 32 be greater than the thickness “t” of the lamina 18. Also, it is important that the cutting edge 24 of blade member 56 be recessed into the channel 32 by at least the distance “r” from the nose 34 of guard member 14 (see FIG. 3). For safety reasons, the width “w” and recess distance “r” need to be sufficient to prevent the user of cutter 10″ from accidentally inserting an appendage (e.g. a finger) into the channel 32 and into contact with the cutting edge 24. As an additional consideration, the sideways distance “d” (see FIG. 4) must be sufficient for this same purpose.

In FIGS. 5 and 6, it can be seen that the handle 12 extends generally in the direction of the axis 20 away from the distal edge 58 through the cutting edge 24 of the blade member 56. More specifically, the handle 12 extends from its distal end 44 to its proximal end 42 to form a handle axis 64. Further, the handle 12 includes a grip 30 at its proximal end 42. The importance of this structure can be seen in FIG. 1.

As shown in FIG. 1, the safety cutter 10 is pulled across a lamina 18, the proximal end 42 of the handle 12 leads the distal end 44 of the handle 12 across a lamina 18. In FIGS. 5 and 6, the relationship between the handle 12 and the cutting edge 24 of the blade member 56 during the movement depicted in FIG. 1 may be understood. Specifically, when the grip 30 of the handle 12 is grasped and pulled by a user, the movement of the handle 12 is generally along the axis 64. As a result, the lamina 18 contacts the nose 34 of the guard member 54 or the cutting edge 24 of the blade member 56. As shown in FIG. 5, the nose 34 slopes toward the edge 59, which creates a nip 66 (shown in FIGS. 6 and 7). Further, with its inclination, the cutting edge 24 of the blade member 56 slopes toward the nip 66. As a result, when the handle 12 is pulled, the lamina 18 is drawn into the nip 66. As shown, the nip 66 forms an acute angle β that prevents relative movement between the cutter 10″ and the lamina 18 unless the lamina 18 is cut. In this manner, the structure of the cutter 10″ provides for cutting of the lamina 18 while only holding the lamina 18 with one hand.

Further, because the guarded blade 36 is easily detached from the handle 12, the cutter 10″ need not be discarded when the blade member 56 becomes dull. Instead, the guarded blade 36 is removed from the handle 12 and disposed of. Then, another guarded blade 36 is positioned in the groove 46 and fixed to the handle 12.

While the particular Lamina Cutter With Disposable Guard as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A safety cutter for cutting a lamina which comprises:
a handle having a first surface and an opposite substantially parallel second surface, a proximal end and a distal end, and a first edge and a second edge extending between the surfaces and between the ends, said handle forming a groove positioned between said first surface and said second surface adjacent the distal end and extending from the first edge toward the second edge;
a guarded blade including a planar blade member permanently bonded to a guard member, with said blade member having a top surface and a bottom surface with a substantially uniform distance “u” therebetween, and said blade member having a first side edge and a second side edge opposite thereto, with a cutting edge and a distal edge respectively extending between the first and second edges, and with said guard member having a first edge, wherein said guard member is bonded directly to the first side edge of said blade member; and
means for detachably connecting the second side edge of the blade member to the groove in the handle to hold said blade member in a channel having a width “w” greater than zero between said handle and said guard member, wherein the channel extends between the cutting edge and the distal edge of said blade member, with said top surface and said bottom surface of said blade member being exposed in the channel from the cutting edge to the distal edge.

2. A safety cutter as recited in claim 1 wherein the guard member is formed from hard plastic.

3. A safety cutter as recited in claim 1 wherein the cutting edge of the blade member and the edge of the guard member form a nip for pinching the lamina during cutting.

4. A safety cutter as recited in claim 3 wherein the handle defines a handle axis and wherein the nip is positioned on the handle axis.

5. A safety cutter as recited in claim 1 wherein the first side edge and the second side edge are each substantially parallel to the axis.

6. A safety cutter as recited in claim 1 wherein said blade member defines a cutting axis extending from the distal edge to the cutting edge and wherein the cutting edge of said blade member is inclined at an angle α relative to the axis.

7. A safety cutter as recited in claim 6 wherein the angle α is less than ninety degrees (α<90°).

8. A safety cutter as recited in claim 1 wherein the width of the channel between said handle and said guard member is greater than approximately 0.125 inches.

9. A safety cutter as recited in claim 1 wherein the connecting means includes an aperture formed on the distal end of the handle, with the aperture passing through the groove, a bore formed adjacent the first side edge of the blade member, and a fastener for passing through the aperture and the bore when the first side edge of the blade member is received within the groove of the handle.

10. A method for manufacturing a safety cutter for cutting a lamina which comprises the steps of:
forming a handle having a first surface and an opposite substantially parallel second surface, a proximal end and a distal end, and a first edge and a second edge extending between the surfaces and between the ends, said handle forming a groove positioned between said first surface and said second surface adjacent the distal end and extending from the first edge toward the second edge;
creating a guarded blade including a planar blade member permanently bonded to a guard member, with said blade member having a top surface and a bottom surface with a substantially uniform distance “u” therebetween, and said blade member having a first side edge and a second side edge opposite thereto, with a cutting edge and a distal edge respectively extending between the first and second edges, and with said guard member having a first edge, wherein said guard member is bonded directly to the first side edge of said blade member; and
detachably connecting the second side edge of the blade member to the groove in the handle to hold said blade member in a channel having a width “w” greater than zero between said handle and said guard member, wherein the channel extends between the cutting edge and the distal edge of said blade member, with said top surface and said bottom surface of said blade member being exposed in the channel from the cutting edge to the distal edge.

11. A method as recited in claim 10 wherein the cutting edge of the blade member and the edge of the guard member form a nip, and wherein, the lamina is pinched by the nip to cut the lamina.

12. A method as recited in claim 11 wherein the handle defines a handle axis and wherein the nip is positioned on the handle axis.

13. A method as recited in claim 10 wherein the creating step is accomplished by chemically bonding the blade member to the guard member.

14. A method as recited in claim 13 wherein said blade member defines a cutting axis extending from the distal edge to the cutting edge and wherein the cutting edge of said blade member is inclined at an angle α relative to the axis, and further wherein the angle α is less than ninety degrees (α<90°).

15. A method for cutting laminae with a safety cutter which comprises the steps of:
providing a safety cutter comprising a handle having a first surface and an opposite substantially parallel second surface, a proximal end and a distal end, and a first edge and a second edge extending between the surfaces and between the ends, said handle forming a groove positioned between said first surface and said second surface adjacent the distal end and extending from the first edge toward the second edge; a plurality of guarded blades, with each guarded blade including a planar blade member permanently bonded to a guard member, with said blade member having a top surface and a bottom surface with a substantially uniform distance “u” therebetween, and said blade member having a first side edge and a second side edge opposite thereto, with a cutting edge and a distal edge respectively extending between the first and second edges, and with said guard member having a first edge, wherein said guard member is bonded directly to the first side edge of said blade member;
selecting a guarded blade;
connecting the second side edge of the blade member of the selected guarded blade to the groove in the handle to hold said blade member in a channel having a width “w” greater than zero between said handle and said guard member, wherein the channel extends between the cutting edge and the distal edge of said blade member, with said top surface and said bottom surface of said blade member being exposed in the channel from the cutting edge to the distal edge;
gripping the proximal end of the handle;
positioning a lamina adjacent the cutting edge of the blade member;
pulling the proximal end of the handle away from the distal end of the handle to advance the lamina through the channel and against the cutting edge to cut the lamina;
disconnecting the second side edge of the blade member of the selected guarded blade from the groove in the handle;
selecting another guarded blade; and
repeating the connecting, gripping, positioning, pulling and disconnecting steps for each selected guarded blade.

16. A method as recited in claim 15 wherein the cutting edge of each blade member and the edge of each guard member form a nip, and wherein, during the pulling step, the lamina is pinched by the nip to cut the lamina.

17. A method as recited in claim 16 wherein the handle defines a handle axis and wherein the nip is positioned on the handle axis.

18. A method as recited in claim 17 wherein, during the pulling step, the handle is pulled substantially along the direction of the handle axis.

19. A method as recited in claim 18 wherein each blade member defines a cutting axis extending from the distal edge to the cutting edge and wherein the cutting edge of said blade member is inclined at an angle α relative to the axis, and further wherein the angle α is less than ninety degrees (α<90°).

20. A method as recited in claim 15 wherein an aperture is formed on the distal end of the handle, with the aperture passing through the groove, wherein a bore is formed adjacent the first side edge of the blade member for alignment with the aperture, and wherein the connecting and disconnecting steps are performed by positioning a fastener in, or removing the fastener from, the aperture and the bore, respectively.
